(19) United States
(12) Patent Application Publication
(10) Pub. No.: US 2025/0208846 A1
(43) Pub. Date: Jun. 26, 2025

(54) METHOD AND RELATED DEVICE FOR ATTRIBUTION OF AN APPLICATION

(71) Applicants: Beijing Zitiao Network Technology Co., Ltd., Haidian District (CN); Beijing Youzhuju Network Technology Co., Ltd., Pinggu District (CN)

(72) Inventors: Xuewu Huang, Beijing (CN); Ye Li, Beijing (CN); Yuting Bian, Beijing (CN); Ruoxing Sheng, Beijing (CN); Zihan Zhao, Beijing (CN); Yuxin Zhang, Beijing (CN); Runshan Wang, Beijing (CN)

(21) Appl. No.: 18/989,994

(22) Filed: Dec. 20, 2024

(30) Foreign Application Priority Data
Dec. 22, 2023 (CN) 202311786922.5

(51) Int. Cl. G06F 8/61

(52) U.S. Cl. CPC G06F 8/61

(57) ABSTRACT

The invention provides a method for attribution of an application, which includes the following steps: in response to an activation event of an application to be attributed, obtaining attribution information from an associated application of the application to be attributed; the associated application being configured to store the attribution information; the associated application and the application to be attributed being both installed in a data partition of a device; and in response to obtaining the attribution information, attributing the application to be attributed based on the attribution information. Based on the method for attribution of the application, the invention further provides an apparatus, an electronic device, a storage medium and a program product for attribution of an application.

### CROSS REFERENCE

This application claims priority of Chinese Patent Application No. CN202311786922.5, filed on Dec. 22, 2023, entitled ‘Method and Related Device for Attribution of An Application’, the entire contents of which are incorporated herein by reference.

### FIELD

The present disclosure relates to the field of computer technologies, and in particular, to a method and a related device for attribution of an application.

### BACKGROUND

Pre-installation refers to presetting the behavior of an application (APP) on a device that is about to be delivered by a manufacturer or an operator, and it is required to accurately identify which source the activation of the APP originates, and then analyze the pre-installation effect.

There are generally three scenarios when the user performs the activation, the first scenario is that the user directly activates the pre-installed version, the second scenario is that the APP is silently upgraded by the application store on the device before the APP is opened by the user, this directly causes the user to open the upgraded version, and the third scenario is that the user reinstalled a version of the application after the pre-installed version is uninstalled. The first scenario is more common, in which the manufacturer or the operator only needs to add some identifications to the pre-installed version of the APP to accurately identify the source corresponding to the APP, and for the second scenario and the third scenario, it is necessary for identifications to have the capability of over-write prevention, thus the prior art adopts a method of setting, in the system, a file in which the information of the pre-installed APP and the pre-installation source number information of the APP are recorded, so that the foregoing over-write prevention file is not affected even if the application is upgraded and reinstalled after uninstallation.

However, because the foregoing over-write prevention file needs to be set in the system, the partner that needs to pre-install the APP is required to have a system-level operation capability, but many partners do not currently have this capability. Secondly, the partner is prone to a configuration error when placing the over-write prevention, which may cause the device that is not pre-installed to also carry the file, resulting in an attribution error.

### SUMMARY

In view of this, an object of the present disclosure is to provide a method and a related device for attribution of an application, which do not require the partner to have a system-level operation capability in use, and effectively avoid occurrence of attribution errors.

According to some embodiments of the present disclosure, the above method for attribution of an application may include: in response to an activation event of an application to be attributed, obtaining attribution information from an associated application of the application to be attributed; the associated application being configured to store the attribution information; the associated application and the application to be attributed being both installed in a data partition of a device; and in response to obtaining the attribution information, attributing the application to be attributed based on the attribution information.

Based on the above method for attribution of an application, an embodiment of the present disclosure provides an apparatus for attribution of an application, comprising:
an obtaining module, configured to, in response to an activation event of an application to be attributed, obtain attribution information from an associated application of the application to be attributed; the associated application being configured to store the attribution information; the associated application and the application to be attributed being both installed in a data partition of a device;
an attributing module, configured to, in response to obtaining the attribution information, attribute the application to be attributed based on the attribution information.

In addition, an embodiment of the present disclosure further provides an electronic device, comprising a memory, a processor, and a computer program stored in the memory and executable on the processor, wherein the program, when executed by the processor, implements the foregoing method.

An embodiment of the present disclosure further provides a non-transitory computer-readable storage medium storing computer instructions, wherein the computer instructions are configured to cause a computer to perform the foregoing method.

An embodiment of the present disclosure further provides a computer program product comprising computer program instructions, wherein the computer program instructions, when running on a computer, cause the computer to perform the foregoing method.

The method and related device for attribution of an application comprise: in response to an activation event of an application to be attributed, obtaining attribution information from an associated application of the application to be attributed; the associated application being configured to store the attribution information; the associated application and the application to be attributed being both installed in a data partition of a device; and in response to obtaining the attribution information, attributing the application to be attributed based on the attribution information. According to the embodiment of the present disclosure, when storing the attribution information, the attribution information is stored by installing an associated application in the data partition of the device, because the associated application is installed in the data partition; therefore, the manufacturer or the operator does not need to have the system-level operation permission, the operation can be completed only by the permission of installing the APP, and the general application software manufacturer may select to send the associated application and the application to be attributed together to the partner when delivery, so that when the partner installs the software on the device, if the application to be attributed needs to be pre-installed, the associated application is installed as well by default, and if the application to be attributed does not need to be pre-installed, the associated application does not normally appear on the device, and because the associated application is received together with the application to be attributed when the associated application is received, the situation that the associated application is installed on the device on which the application to be attributed is not required to be installed is generally avoided. It can be known from the foregoing statement that, in the embodiments of the present disclosure, the partner without the system-level operation permission can successfully attribute the application to be attributed, and meanwhile, it can be ensured that no associated application appears on the device that does not need to pre-install the application to be attributed, thereby effectively reducing the occurrence of the attribution error.

### BRIEF DESCRIPTION OF THE DRAWINGS

In order to more clearly illustrate the technical solutions in the present disclosure or related technologies, the accompanying drawings, which need to be used in the description of the embodiments or related technologies, are briefly introduced below, and obviously, the drawings in the following description are merely embodiments of the present disclosure, and for those of ordinary skill in the art, other drawings may be obtained according to these drawings without creative work.

FIG. 1 shows an implementation flow of a method for attribution of an application according to some embodiments of the present disclosure;

FIG. 2 is a schematic diagram of an apparatus for attribution of an application according to some embodiments of the present disclosure;

FIG. 3 is a schematic diagram of a hardware structural of an electronic device according to an embodiment of the present disclosure.

### DETAILED DESCRIPTION

In order to make the objectives, technical solutions and advantages of the present disclosure clearer, the present disclosure will be further described in detail below with reference to the accompanying drawings.

It should be noted that, unless otherwise defined, technical terms or scientific terms used in the embodiments of the present disclosure should be of ordinary meanings understood by those skilled in the art to which the present disclosure belongs. The terms “first”, “second” and similar terms used in the embodiments of the present disclosure do not represent any order, quantity, or importance, but are merely used to distinguish different components. A word “comprising” or “including” or the like means that an element or object appearing in front of the word encompasses elements or objects appearing behind the word and their equivalents, without excluding other elements or objects. Similar terms such as “connected” or “in connection” are not limited to physical or mechanical connections, but may include electrical connections, whether direct or indirect. “Upper”, “lower”, “left”, “right” and the like are only used to represent relative position relationships, and when the absolute position of the object to be described changes, the relative position relationship may also change accordingly.

It may be understood that, before the technical solutions of the embodiments of the present disclosure are used, the user may be notified of the type, the usage scope, the usage scenario and the like of the involved personal information, in an appropriate manner, and the authorization of the user is obtained.

For example, in response to receiving an active request from a user, prompt information is sent to the user to explicitly prompt the user that the operation requested to be performed will need to acquire and use the personal information of the user. Therefore, the user can autonomously select whether to provide personal information to software or hardware such as electronic device, application, server or storage medium executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

As described above, there are generally three scenarios when the user performs the activation, the first scenario is that the user directly activates the pre-installed version, the second scenario is that the APP is silently upgraded by the application store on the device before the APP is opened by the user, this directly causes the user to open the upgraded version, and the third scenario is that the user reinstalled a version of the application after the pre-installed version is uninstalled. The first scenario is more common, in which the manufacturer or the operator only needs to add some identifications to the pre-installed version of the APP to accurately identify the source corresponding to the APP, and for the second scenario and the third scenario, it is necessary for identifications to have the capability of over-write prevention, thus the prior art adopts a method of setting, in the system, a file in which the information of the pre-installed APP and the pre-installation source number information of the APP are recorded, so that the foregoing over-write prevention file is not affected even if the application is upgraded and reinstalled after uninstallation. However, because the foregoing over-write prevention file needs to be set in the system, the partner that needs to pre-install the APP is required to have a system-level operation capability, but many partners do not currently have this capability. Secondly, the partner is prone to a configuration error when placing the over-write prevention, which may cause the device that is not pre-installed to also carry the file, resulting in an attribution error.

Therefore, some embodiments of the present disclosure provide a method for attribution of an application, by placing information to be used in an associated application installed in a data partition of a device, the partner is no longer required to have the operation capability of the system-level, it is only required to have the permission to install the application on the device, and because the application manufacturer generally sends the application to be attributed and the associated application to the partner to the partner together when the application manufacturer is sending the application to be attributed to the partner, and the partner may install the two by default at the time of installation, that is, if the application to be attributed needs to be installed, the associated application is installed to the device by default, and the associated application does not need to be installed on a device that is not required to install the application to be attributed, so that the associated application can be effectively prevented from being separately present on the device, the absence of the associated application on the device can be effectively avoided, and the occurrence of the attribution error can be effectively prevented.

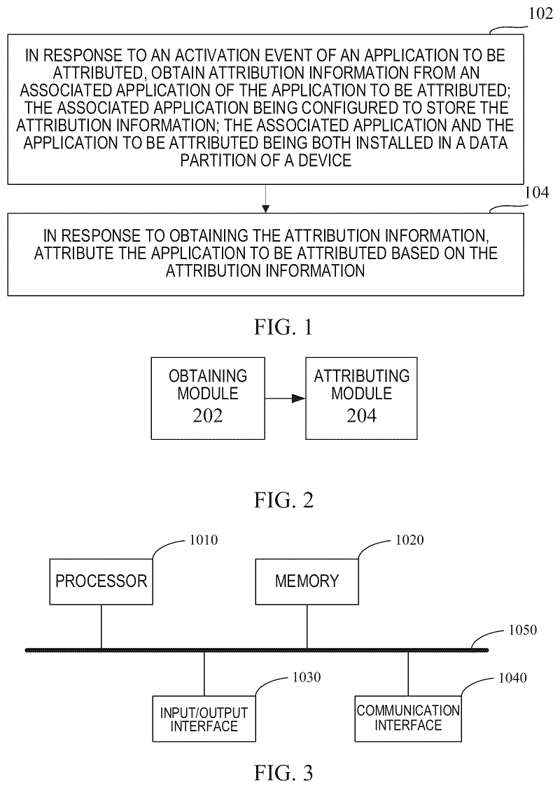

As shown in FIG. 1, the method may include the following steps:

In step 101, in response to an activation event of an application to be attributed, obtain attribution information from an associated application of the application to be attributed; the associated application being configured to store the attribution information; the associated application and the application to be attributed being both installed in a data partition of a device;

In an embodiment of the present disclosure, the activation event of the application to be attributed generally refers to a behavior of the user to open the application for the first time after obtaining the device. The application to be attributed refers to an application that has not been attributed, and attributing the application refers to determining the installation source of the application, so that the application manufacturer can determine the usage and installation situation of the user of each source according to the number of the attribution.

In the embodiments of the present disclosure, the technical features of the associated application are creatively proposed, and compared with the installation of the over-write prevention file for attribution in the system partition in the prior art, the associated application is also installed in the data partition of the device as the application to be attributed. More diversified information may be stored in the associated application because the nature thereof is used for attribution, and it thus may include a pre-installation collaboration source number that needs to be used. In addition, because in the embodiments of the present disclosure, related information is stored by using an associated application, many other information may be added therein, for example, a source number may be refined, a source number of which specific year may be distinguished, a pre-installation version number may also be stored, and used to provide statistical related information to an application manufacturer, and the application manufacturer may further adjust itself according to the data. In addition, those skilled in the art may further store the required information for use in the associated application according to their own needs.

In some embodiments of the present disclosure, the icon of the associated application is set to be invisible to the user.

In the embodiments of the present disclosure, because the associated application is installed in the device in the form of an application program, there may be two same application icons in the field of view of the user, in order to enable the user to obtain a better user experience, the icon of the associated application may be set to be invisible to the user, so that no obvious perception exists on the user side, of course, because the associated application still exists in the device, the application program can be found in the setting interface. It should be emphasized that, in the embodiments of the present disclosure, setting the icon of the associated application to be invisible to the user is not intended to hide it from the user, but for the user experience, of course, the associated application may grant the user with a permission of whether the icon is visible, that is, the user may automatically control whether the associated application is visible, so that the use experience of the user may be better ensured.

Specifically, when the icon of the associated application is set to be invisible, the related configuration may be removed through an intent-filter corresponding to each activity of the application bootup class.

In some embodiments of the present disclosure, the associated application is configured with a first signature; the application to be attributed is configured with a second signature; obtaining the attribution information from the associated application of the application to be attributed comprises: determining whether the attribution information is allowed to be obtained from the associated application based on a relationship between the first signature and the second signature.

In the embodiments of the present disclosure, after the application to be attributed is activated, the application to be attributed needs to obtain the corresponding attribution information from the associated application corresponding to the application to be attributed, and before obtaining the attribution information, the relationship between the signature of the associated application and the signature of the application to be attributed needs to be first determined, and the conclusion of whether the corresponding information can be obtained from the associated application can be determined according to the relationship.

In some embodiments of the present disclosure, determining whether the attribution information is allowed to be obtained from the associated application based on the relationship between the first signature and the second signature comprises: determining whether the first signature is the same as the second signature; and in response to the first signature being the same as the second signature, determining that the attribution information is allowed to be obtained from the association application.

As described above, the setting of the signature is that only the same application will have the same signature, so the determination condition can be set to determining whether the signature of the associated application is the same as the signature of the application to be attributed, and only if the signatures of the two are the same, the application to be attributed can obtain the information stored therein from the associated application.

Specifically, with respect to the setting of the signature, a content provider may be added to the associated application, a permission verification is added to the provider, and a protection level of the permission is set as signature, the property, i.e. the protection level of the permission is the key of permission control, and the foregoing signature refers to that only the application with the same signature can use the permission. Similarly, in the pre-installed application, it also needs to actively claim the protection permission of the provider set in the associated application, so that if the application is activated, the information stored in the provider is naturally obtained from the associated application.

In the prior art, because the over-write prevention file needs to be installed in the system partition of the device to be prevented from being over-write, all applications installed on the device can read the over-write prevention file, obviously, the prior art cannot ensure the security of the stored information in the over-write prevention file, or in other words the over-write prevention file is disclosed in essence, and in the embodiment of the present disclosure, the corresponding signature is set for both the associated application and the pre-installed application, and the signature of the associated application is limited to be the same as the signature of the pre-installed application, where the range of the signature being the same here can be expanded to the application of any source, that is, no matter what source, it is only required that the application is the same, it can be ensured that the information stored in the associated application can only be obtained by the same application. Obviously, comparing to the prior art, the embodiment of the present disclosure can effectively ensure the security of the information stored in the associated application.

In step 102, in response to obtaining the attribution information, attribute the application to be attributed based on the attribution information.

In some embodiments of the present disclosure, the attribution information includes a first installation time of the associated application; and attributing the application to be attributed based on the attribution information comprises: obtaining a latest installation time of the application to be attributed; and attributing the application to be attributed based on the first installation time and the latest installation time.

In the prior art, because the over-write prevention file for the attribution is stored in the system, the pre-installed application, whether upgraded or reinstalled after uninstalled, can still obtain the attribution information of the pre-installed application from the system, and if the pre-installed application is activated by the user after the silent upgrade, the pre-installed application should be attributed as the pre-installation source, but if the pre-installed application is uninstalled and then the application to be attributed is reinstalled from the other source, at this time, the application to be attributed should not be attributed as the pre-installation source, but it is obvious that in the prior art, the pre-installed application is still attributed as the pre-installation source, which can lead to the final attribution result being inaccurate. In addition, for a user that performs the uninstallation and the reinstallation, even if the application is not pre-installed on the device, the user may also actively download the application, and for an application manufacturer, it is necessary to subdivide this part of users. Therefore, in the embodiments of the present disclosure, the concept of the installation time is additionally introduced, and the installation time is used to distinguish whether the application is silently upgraded or the application is uninstalled and reinstalled by the user, so as to better distinguish the user category, thereby improving the application thereof, and finally effectively improving the user experience.

In some embodiments of the present disclosure, the attribution information comprises a first installation time of the associated application; and attributing the application to be attributed based on the attribution information comprises: obtaining a latest installation time of the application to be attributed; and attributing the application to be attributed based on the first installation time and the latest installation time.

Specifically, when the attributing application to be attributed, it is necessary to obtain the first installation time of the associated application and the latest installation time of the application to be attributed, since both the associated application and the pre-installed application are installed on the device almost at the same time, if the application to be attributed is the original pre-installed application, the installation time thereof does not change, and then the difference between the installation time of the pre-installed application and the associated application should be very small, and then a reasonable threshold may be set according to the time, of course, the threshold itself may be very small, because it adapts to the installation time difference of the pre-installed application and the associated application, and because the installation time difference between the pre-installed application and the associated application is small, the threshold will naturally also be small.

In some embodiments of the present disclosure, attributing the application to be attributed based on the first installation time and the latest installation time comprises: determining whether an absolute value of a difference between the first installation time and the latest installation time is less than or equal to a predetermined threshold; in response to the absolute value of the difference between the first installation time and the latest installation time being less than or equal to the predetermined threshold, attributing the application to be attributed to a pre-installation source; in response to the absolute value of the difference between the first installation time and the latest installation time being greater than the predetermined threshold, attributing the application to be attributed to a source corresponding to the application to be attributed upon uninstallation and reinstallation of the application to be attributed.

For the silent upgraded application, which is silently upgraded by an application store in the device, but the installation time thereof is not changed, so when the installation time of the application is obtained, the obtained installation time natural still is the time when the application is pre-installed, and when compared with the installation time stored in the associated application, the installation time is very close to the installation time stored in the associated application.

For the application to be attributed upon uninstallation and reinstallation, because there is an uninstallation action and after which the application is reinstalled, the installation time of the application to be attributed is updated to be the time when the application reinstalled, obviously, after the application is uninstalled and reinstalled, the reinstallation time is of course different from the time when the associated application is installed.

Therefore, it can be known in combination with the foregoing content that, by setting the time difference threshold of the application to be attributed and the pre-installed application, it can be determined whether the application to be attributed at this time is the original pre-installed application or the upgraded application or the application upon uninstallation and reinstallation.

During specific comparison, the latest installation time of the application to be attributed is obtained, the installation time of the associated application is obtained, difference processing is performed between the latest installation time and the installation time of the associated application, then the absolute value of the difference of the two is taken, and the relationship between the absolute value and the foregoing set threshold is compared, and if the absolute value of the difference between the first installation time and the latest installation time is less than or equal to the predetermined threshold, the application to be attributed is attributed to the pre-installation source; and when the absolute value of the difference between the first installation time and the latest installation time is greater than the predetermined threshold, the application to be attributed is attributed to a source corresponding to the application to be attributed upon uninstallation and reinstallation.

In some embodiments of the present disclosure, the attribution information comprises a pre-installation collaboration source number; and in response to the absolute value of the difference between the first installation time and the latest installation time being less than or equal to the predetermined threshold, attributing the application to be attributed to the pre-installation source comprises: in response to the absolute value of the difference between the first installation time and the latest installation time being less than or equal to the predetermined threshold, obtaining the pre-installation collaboration source number from the associated application; and attributing the application to be attributed to the pre-installation source based on the pre-installation collaboration source number.

In an embodiment of the present disclosure, if the absolute value of the difference between the first installation time and the latest installation time is less than or equal to the predetermined threshold, the pre-installation collaboration source number is obtained from the associated application, and the application to be attributed is attributed to the pre-installation source corresponding to the source number according to the source number.

According to the method for attribution of an application, an associated application is installed in a data partition of the device to store, because the associated application is installed in the data partition, the manufacturer or the operator does not need to have the operation permission of the system-level, only the permission of installing the APP is required to complete the above operation, and when the general application software manufacturer selects to send the associated application and the application to be attributed to the partner together when the application is delivered, when the partner installs the software on the device, if the application to be attributed needs to be pre-installed, the associated application is installed by default, and if the application to be attributed does not need to be pre-installed, the associated application does not generally appear on the device, because when the associated application is received, the associated application is received together with the application to be attributed, the situation that the associated application is installed on a device on which the pre-installation of the application to be attributed is not required is generally avoided. It can be known from the foregoing statement that, in the embodiments of the present disclosure, the partner without the system-level operation permission can successfully attribute the application to be attributed, and meanwhile, it can be ensured that no associated application appears on the device that does not need to pre-install the application to be attributed, thereby effectively reducing the occurrence of the attribution error. In addition, the concept of the installation time is additionally introduced in the present disclosure, and by determining the relationship between the absolute value of the installation time difference between the application to be attributed and the associated application and the threshold, it can be further determined whether the source of the application to be attributed is still the pre-installation source, that is, the pre-installed application that is silently upgraded and the application upon uninstallation and reinstallation can be distinguished, so that the user category can be better distinguished, thereby improving the application itself, and finally, effectively improving the user experience.

It should be noted that the method in the embodiments of the present disclosure may be performed by a single device, for example, a computer or a server. The method in this embodiment may also be applied to a distributed scenario, and the plurality of devices cooperate to complete. In this distributed scenario, one of the plurality of devices may perform only one or more steps in the method in the embodiments of the present disclosure, and the plurality of devices interact with each other to complete the method.

It should be noted that some embodiments of the present disclosure are described above. Other embodiments are within the scope of the appended claims. In some cases, the acts or steps recited in the claims may be performed in a different order than in the above embodiments and still achieve the desired results. Additionally, the processes depicted in the figures do not necessarily require a particular order or sequential order shown to achieve the desired results. In certain embodiments, multitasking and parallel processing are also possible or may be advantageous.

Based on the same inventive concept, corresponding to any of the above embodiments, the present disclosure further provides an apparatus for attribution of an application.

Referring to FIG. 2, an apparatus for attribution of an application includes:
an obtaining module 21, configured to, in response to an activation event of an application to be attributed, obtain attribution information from an associated application of the application to be attributed; the associated application being configured to store the attribution information; the associated application and the application to be attributed being both installed in a data partition of a device.
an attributing module 22, configured to, in response to obtaining the attribution information, attribute the application to be attributed based on the attribution information.

In some embodiments of the present disclosure, the associated application is configured with a first signature; and the application to be attributed is configured with a second signature.

The obtaining module 21 includes:
a determining unit, configured to determine whether the attribution information is allowed to be obtained from the associated application based on a relationship between the first signature and the second signature.

In some embodiments of the present disclosure, the determining unit includes:
determining whether the first signature is the same as the second signature;
in response to the first signature being the same as the second signature, determining that the attribution information is allowed to be obtained from the association application.

In some embodiments of the present disclosure, the attribution information comprises a first installation time of the associated application.

The attributing module comprises:

An installation time obtaining unit, configured to obtain a latest installation time of the application to be attributed;
an attributing unit, configured to attribute the application to be attributed based on the first installation time and the latest installation time.

In some embodiments of the present disclosure, the attributing unit comprises:
determining whether an absolute value of a difference between the first installation time and the latest installation time is less than or equal to a predetermined threshold;
in response to the absolute value of the difference between the first installation time and the latest installation time being less than or equal to the predetermined threshold, attributing the application to be attributed to a pre-installation source;
in response to the absolute value of the difference between the first installation time and the latest installation time being greater than the predetermined threshold, attributing the application to be attributed to a source corresponding to the application to be attributed upon uninstallation and reinstallation of the application to be attributed.

In some embodiments of the present disclosure, the attribution information comprises a pre-installation collaboration source number.

The attributing unit comprises:
in response to the absolute value of the difference between the first installation time and the latest installation time being less than or equal to the predetermined threshold, obtaining the pre-installation collaboration source number from the associated application;
attributing the application to be attributed to the pre-installation source based on the pre-installation collaboration source number.

In some embodiments of the present disclosure, an icon of the associated application is set to be invisible to a user.

For convenience of description, the above apparatus is respectively described as if the above apparatus is divided into various modules by functions. Of course, the functions of the modules may be implemented in one or more software and/or hardware when implementing the present disclosure.

The apparatus of the foregoing embodiment is configured to implement the corresponding method for attribution of an application in any one of the foregoing embodiments, and has the beneficial effects of the corresponding method embodiments, and details are not described herein again.

Based on the same inventive concept, corresponding to the foregoing embodiment methods, the present disclosure further provides an electronic device, including a memory, a processor, and a computer program stored in the memory and executable on the processor, where the processor executes the program to implement the method for attribution of the application according to any one of the foregoing embodiments.

FIG. 3 is a schematic structural diagram of a more specific hardware structure of an electronic device according to this embodiment, and the device may include a processor 1010, a memory 1020, an input/output interface 1030, a communication interface 1040, and a bus 1050. The processor 1010, the memory 1020, the input/output interface 1030, and the communication interface 1040 implement, by using the bus 1050, a communication connection with each other inside the device.

The processor 1010 may be implemented by using a general-purpose central processing unit (CPU), a microprocessor, an application specific integrated circuit (ASIC), or one or more integrated circuits, and is configured to execute related programs to implement the technical solutions provided in the embodiments of the present specification.

The memory 1020 may be implemented in a form of a ROM (Read Only Memory), a Random Access Memory (RAM), a static storage device, a dynamic storage device, or the like. The memory 1020 may store an operating system and other applications, and when implementing the technical solutions provided in the embodiments of the present specification by using software or firmware, related program code is stored in the memory 1020 and invoked and executed by the processor 1010.

The input/output interface 1030 is configured to connect the input/output module to implement information input and output. The input/output/module may be configured as a component in the device (not shown in the figure), or may be externally connected to the device to provide a corresponding function. The input device may include a keyboard, a mouse, a touch screen, a microphone, various sensors, etc., and the output device may include a display, a speaker, a vibrator, an indicator light, and the like.

The communication interface 1040 is configured to connect a communications module (not shown in the figure), to implement communications interaction between the device and another device. The communications module may implement communications in a wired manner (for example, a USB or a network cable), or may implement communications in a wireless manner (for example, a mobile network, a Wi-Fi, a Bluetooth, and the like).

The bus 1050 includes a path to transfer information between various components of the device, such as the processor 1010, the memory 1020, the input/output interface 1030, and the communication interface 1040.

It should be noted that although the foregoing device only shows the processor 1010, the memory 1020, the input/output interface 1030, the communication interface 1040, and the bus 1050, in a specific implementation process, the device may further include other components necessary to implement normal running. In addition, those skilled in the art may understand that the foregoing device may also include only components necessary for implementing the solutions in the embodiments of the present specification, and does not necessarily include all components shown in the figure.

The electronic device of the foregoing embodiment is configured to implement the corresponding method for attribution of the application in any one of the foregoing embodiments, and has the beneficial effects of the corresponding method embodiments, and details are not described herein again.

Based on the same inventive concept, the present disclosure further provides a non-transitory computer-readable storage medium storing computer instructions for causing the computer to perform the method for attribution of an application according to any one of the above embodiments.

Computer-readable media of the present embodiments include permanent and non-permanent, removable and non-removable media that can be stored by any method or technology. The information may be computer readable instructions, data structures, modules of a program, or other data. Examples of computer storage media include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disc read-only memory (CD-ROM), digital versatile disc (DVD) or other optical storage, magnetic cassettes, magnetic tape magnetic disk storage or other magnetic storage devices, or any other non-transmission medium, which can be used to store information that can be accessed by a computing device.

The computer instructions stored in the storage medium in the foregoing embodiments are configured to cause the computer to perform the method for attribution of the application as described in any one of the foregoing embodiments, and have the beneficial effects of the corresponding method embodiments, and details are not described herein again.

Based on the same inventive concept, the present disclosure further provides a computer program product comprising computer program instructions. In some embodiments, the computer program instructions may be executed by one or more processors of a computer to cause the computer and/or the processor to perform the attribution method of the application. Corresponding to the executing body corresponding to each step in each embodiment of the attribution method of the application, the processor executing the corresponding step may belong to the corresponding executing body.

The computer program product of the foregoing embodiment is configured to cause the computer and/or the processor to perform the method for attribution of the application according to any one of the above embodiments, and has the beneficial effects of the corresponding method embodiments, and details are not described herein again.

It should be understood by those of ordinary skill in the art that the discussion of any of the above embodiments is merely exemplary and is not intended to suggest that the scope of the present disclosure, including the claims, is limited to these examples; in the spirit of the present disclosure, the above embodiments or the technical features in different embodiments may also be combined, the steps may be implemented in any order, and there are many other variations of the different aspects of the embodiments of the present disclosure as described above, which are not provided in detail for the sake of brevity.

Additionally, for simplicity of illustration and discussion, and to not obscure embodiments of the present disclosure, well-known power/ground connections to integrated circuit (IC) chips and other components may or may not be shown in the figures provided. Moreover, the apparatus may be shown in block diagram form in order to avoid obscuring the embodiments of the present disclosure, and this also takes into account the fact that the details regarding the implementation of these block diagram devices are highly dependent on the platform in which the embodiments of the present disclosure are to be implemented (i.e., these details should be fully within the understanding of those skilled in the art). Having set forth specific details (e.g., circuits) to describe exemplary embodiments of the present disclosure, it will be apparent to those skilled in the art that embodiments of the present disclosure may be practiced without these specific details or with changes to these specific details. Accordingly, these descriptions should be considered illustrative and not limiting.

Although the present disclosure has been described in conjunction with specific embodiments of the present disclosure, many alternatives, modifications, and variations of these embodiments will be apparent to those of ordinary skill in the art from the foregoing description. For example, other memory architectures (e.g., dynamic RAM (DRAM)) may use the embodiments discussed.

The present disclosure is intended to cover all such alternatives, modifications and variations that fall within the broad scope of the appended claims. Therefore, any omission, modification, equivalent replacement, improvement and the like that are made within the spirit and principle of the embodiments of the present disclosure should be included within the protection scope of the present disclosure.

I/We claim:

1. A method for attribution of an application, comprising:
in response to an activation event of an application to be attributed, obtaining attribution information from an associated application of the application to be attributed; the associated application being configured to store the attribution information; the associated application and the application to be attributed being both installed in a data partition of a device; and
in response to obtaining the attribution information, attributing the application to be attributed based on the attribution information.

2. The method of claim 1, wherein the associated application is configured with a first signature; and the application to be attributed is configured with a second signature;
obtaining the attribution information from the associated application of the application to be attributed comprises:
determining whether the attribution information is allowed to be obtained from the associated application based on a relationship between the first signature and the second signature.

3. The method of claim 2, wherein determining whether the attribution information is allowed to be obtained from the associated application based on the relationship between the first signature and the second signature comprises:
determining whether the first signature is the same as the second signature; and
in response to the first signature being the same as the second signature, determining that the attribution information is allowed to be obtained from the association application.

4. The method of claim 1, wherein the attribution information comprises a first installation time of the associated application;
attributing the application to be attributed based on the attribution information comprises:
obtaining a latest installation time of the application to be attributed; and
attributing the application to be attributed based on the first installation time and the latest installation time.

5. The method of claim 4, wherein attributing the application to be attributed based on the first installation time and the latest installation time comprises:
determining whether an absolute value of a difference between the first installation time and the latest installation time is less than or equal to a predetermined threshold;
in response to the absolute value of the difference between the first installation time and the latest installation time being less than or equal to the predetermined threshold, attributing the application to be attributed to a pre-installation source; and
in response to the absolute value of the difference between the first installation time and the latest installation time being greater than the predetermined threshold, attributing the application to be attributed to a source corresponding to the application to be attributed upon uninstallation and reinstallation of the application to be attributed.

6. The method of claim 5, wherein the attribution information comprises a pre-installation collaboration source number;
in response to the absolute value of the difference between the first installation time and the latest installation time being less than or equal to the predetermined threshold, attributing the application to be attributed to the pre-installation source comprises:
in response to the absolute value of the difference between the first installation time and the latest installation time being less than or equal to the predetermined threshold, obtaining the pre-installation collaboration source number from the associated application; and
attributing the application to be attributed to the pre-installation source based on the pre-installation collaboration source number.

7. The method of claim 1, wherein an icon of the associated application is set to be invisible to a user.

8. An electronic device, comprising a memory, a processor, and a computer program stored in the memory and executable on the processor, wherein the program, when executed by the processor, implements a method for attribution of an application, comprising:
in response to an activation event of an application to be attributed, obtaining attribution information from an associated application of the application to be attributed; the associated application being configured to store the attribution information; the associated application and the application to be attributed being both installed in a data partition of a device; and
in response to obtaining the attribution information, attributing the application to be attributed based on the attribution information.

9. The electronic device of claim 8, wherein the associated application is configured with a first signature; and the application to be attributed is configured with a second signature;
obtaining the attribution information from the associated application of the application to be attributed comprises:
determining whether the attribution information is allowed to be obtained from the associated application based on a relationship between the first signature and the second signature.

10. The electronic device of claim 9, wherein determining whether the attribution information is allowed to be obtained from the associated application based on the relationship between the first signature and the second signature comprises:
determining whether the first signature is the same as the second signature; and
in response to the first signature being the same as the second signature, determining that the attribution information is allowed to be obtained from the association application.

11. The electronic device of claim 8, wherein the attribution information comprises a first installation time of the associated application;
attributing the application to be attributed based on the attribution information comprises:
obtaining a latest installation time of the application to be attributed; and
attributing the application to be attributed based on the first installation time and the latest installation time.

12. The electronic device of claim 11, wherein attributing the application to be attributed based on the first installation time and the latest installation time comprises:
determining whether an absolute value of a difference between the first installation time and the latest installation time is less than or equal to a predetermined threshold;
in response to the absolute value of the difference between the first installation time and the latest installation time being less than or equal to the predetermined threshold, attributing the application to be attributed to a pre-installation source; and
in response to the absolute value of the difference between the first installation time and the latest installation time being greater than the predetermined threshold, attributing the application to be attributed to a source corresponding to the application to be attributed upon uninstallation and reinstallation of the application to be attributed.

13. The electronic device of claim 12, wherein the attribution information comprises a pre-installation collaboration source number;
in response to the absolute value of the difference between the first installation time and the latest installation time being less than or equal to the predetermined threshold, attributing the application to be attributed to the pre-installation source comprises:
in response to the absolute value of the difference between the first installation time and the latest installation time being less than or equal to the predetermined threshold, obtaining the pre-installation collaboration source number from the associated application; and
attributing the application to be attributed to the pre-installation source based on the pre-installation collaboration source number.

14. The electronic device of claim 8, wherein an icon of the associated application is set to be invisible to a user.

15. A non-transitory computer-readable storage medium storing computer instructions, wherein the computer instructions are configured to cause a computer to perform a method for attribution of an application, comprising:
in response to an activation event of an application to be attributed, obtaining attribution information from an associated application of the application to be attributed; the associated application being configured to store the attribution information; the associated application and the application to be attributed being both installed in a data partition of a device; and
in response to obtaining the attribution information, attributing the application to be attributed based on the attribution information.

16. The non-transitory computer-readable storage medium of claim 15, wherein the associated application is configured with a first signature; and the application to be attributed is configured with a second signature;
obtaining the attribution information from the associated application of the application to be attributed comprises:
determining whether the attribution information is allowed to be obtained from the associated application based on a relationship between the first signature and the second signature.

17. The non-transitory computer-readable storage medium of claim 16, wherein determining whether the attribution information is allowed to be obtained from the associated application based on the relationship between the first signature and the second signature comprises:
determining whether the first signature is the same as the second signature; and
in response to the first signature being the same as the second signature, determining that the attribution information is allowed to be obtained from the association application.

18. The non-transitory computer-readable storage medium of claim 15, wherein the attribution information comprises a first installation time of the associated application;
attributing the application to be attributed based on the attribution information comprises:
obtaining a latest installation time of the application to be attributed; and
attributing the application to be attributed based on the first installation time and the latest installation time.

19. The non-transitory computer-readable storage medium of claim 18, wherein attributing the application to be attributed based on the first installation time and the latest installation time comprises:
determining whether an absolute value of a difference between the first installation time and the latest installation time is less than or equal to a predetermined threshold;
in response to the absolute value of the difference between the first installation time and the latest installation time being less than or equal to the predetermined threshold, attributing the application to be attributed to a pre-installation source; and
in response to the absolute value of the difference between the first installation time and the latest installation time being greater than the predetermined threshold, attributing the application to be attributed to a source corresponding to the application to be attributed upon uninstallation and reinstallation of the application to be attributed.

20. The non-transitory computer-readable storage medium of claim 19, wherein the attribution information comprises a pre-installation collaboration source number;
in response to the absolute value of the difference between the first installation time and the latest installation time being less than or equal to the predetermined threshold, attributing the application to be attributed to the pre-installation source comprises:
in response to the absolute value of the difference between the first installation time and the latest installation time being less than or equal to the predetermined threshold, obtaining the pre-installation collaboration source number from the associated application; and
attributing the application to be attributed to the pre-installation source based on the pre-installation collaboration source number.
